(19) United States
(12) Patent Application Publication
(10) Pub. No.: US 2016/0349977 A1
(43) Pub. Date: Dec. 1, 2016

(54) METHOD AND DEVICE FOR OPERATING CONTROLS IN TERMINAL BASED ON REMOTE-CONTROL EQUIPMENT

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Wenxuan SONG, Tianjin (CN); Jia YU, Tianjin (CN); Jiazi TIAN, Tianjin (CN); Lei YAN, Tianjin (CN); Haibo TANG, Tianjin (CN)

(21) Appl. No.: 15/235,018

(22) Filed: Aug. 11, 2016

Related U.S. Application Data
(63) Continuation of application No. PCT/CN2015/082245, filed on Jun. 24, 2015.

(30) Foreign Application Priority Data
Jul. 31, 2014 (CN) 201410378722.0

(51) Int. Cl. G06F 3/0484; G06F 3/0488; G06F 3/0481

(52) U.S. Cl. CPC G06F 3/04847; G06F 3/04817; G06F 3/0488

(57) ABSTRACT

Disclosed is a method and device for operating controls in a terminal based on remote-control equipment, which is able to address the problems that the remote-control equipment in the prior art cannot conveniently operate the controls in many ways and the operating requirements of the user cannot be satisfied. Herein, the method comprises steps of: obtaining a controls management instruction sent from remote-control equipment to allow controls to enter a displacement control operation mode according to the controls management instruction; recognizing an operation instruction sent for the controls in the terminal in the mode from the remote-control equipment, wherein the operation instruction is used to move the controls in the terminal from a source position to a target position; and moving the controls in the terminal from a source position to a target position in response to the operation instruction.

### CROSS-REFERENCE TO RELATED APPLICATIONS

This application is a continuation of International Application No. PCT/CN2015/082245, filed on Jun. 24, 2015, which is based upon and claims priority to Chinese Patent Application No. 201410378722.0, filed on Jul. 31, 2014, the entire contents of which are incorporated herein by reference.

### TECHNICAL FIELD

The present disclosure relates to the field of multimedia technologies, and in particular to a method and device for operating controls in terminal based on remote-control equipment.

### BACKGROUND

Smart television is directed to a new model of television having a full-open platform and provided with an operating system, through which a user can install and uninstall various applications by himself or herself while enjoying general television programs, so that functions thereof can be continuously extended and updated.

With the development of the smart television, increasing television applications and programs have emerged. A variety of controls, such as app icons corresponding to installed applications in the television, may be displayed in an interface of the television. For the smart television, at present, only a selecting operation can be made to the controls in the interface often by using remote-control equipment. For example, an app icon is selected to enter an application as required by a user through the remote-control equipment. In practical use, however, the user may conceive varied operating requirements (such as, movement of controls, management of controls, etc.) to the controls in the interface. On the contrary, the remote-control equipment in the prior art cannot conveniently operate the controls in many ways. Therefore, the operating requirements of the user cannot be satisfied.

### SUMMARY

The disclosure provides a method and device for operating controls in terminal based on remote-control equipment, which is able to address the problems that the remote-control equipment in the prior art cannot conveniently operate the controls in many ways and the operating requirements of the user cannot be satisfied.

To address above problems, there is provided a method for operating controls in a terminal based on remote-control equipment in the disclosure, wherein the method includes steps of:

obtaining a controls management instruction sent from remote-control equipment to allow controls to enter a displacement control operation mode according to the controls management instruction, wherein the operation instruction is used to move the controls in the terminal from a source position to a target position;

recognizing an operation instruction sent for the controls in the terminal in the mode from the remote-control equipment; and

moving the controls in the terminal from a source position to a target position in response to the operation instruction.

According to another aspect of the disclosure, there is provided an electronic device for operating controls in terminal based on remote-control equipment in the disclosure, wherein the electronic device includes:

at least one processor; and

a memory communicably connected with the at least one processor for storing instructions executable by the at least one processor, wherein execution of the instructions by the at least one processor causes the at least one processor to:

obtain a controls management instruction sent from remote-control equipment to allow controls to enter a displacement control operation mode according to the controls management instruction;

recognize an operation instruction sent for the controls in the terminal in the mode from the remote-control equipment, wherein the operation instruction is used to move the controls in the terminal from a source position to a target position; and

move the controls in the terminal from a source position to a target position in response to the operation instruction.

Compared to the prior art, the disclosure have following advantages:

in the disclosure, it is possible first to obtain a controls management instruction sent from remote-control equipment to allow controls to enter a displacement control operation mode according to the controls management instruction; then recognize an operation instruction sent for the controls in the terminal in the mode from the remote-control equipment, wherein the operation instruction is used to move the controls in the terminal from a source position to a target position; finally move the controls in the terminal from a source position to a target position in response to the operation instruction. Since, in the disclosure, the operation instruction for moving the controls in the terminal from a source position to a target position can be sent through the remote-control equipment, a variety of operations can be conveniently made to the controls in the terminal through the remote-control equipment to satisfy the operation requirements of the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for operating controls in a terminal based on remote-control equipment according to a first embodiment of the disclosure.

FIG. 2 is a flow chart of a method for operating controls in a terminal based on remote-control equipment according to a second embodiment of the disclosure.

FIG. 3 is a schematic diagram of an entry to a displacement control operation mode according to the second embodiment of the disclosure.

FIG. 4 is a schematic diagram of displacement of controls in a terminal from a source position to a target position according to the second embodiment of the disclosure.

FIG. 5 is another schematic diagram of displacement of controls in a terminal from a source position to a target position according to the second embodiment of the disclosure.

FIG. 6 is still another schematic diagram of displacement of controls in a terminal from a source position to a target position according to the second embodiment of the disclosure.

FIG. 7 is a block diagram of a device for operating controls in terminal based on remote-control equipment according to a third embodiment of the disclosure.

FIG. 8 is a block diagram of a device for operating controls in terminal based on remote-control equipment according to a fourth embodiment of the disclosure.

FIG. 9 schematically depicts a block diagram of an electronic device for executing the method according to the present disclosure.

FIG. 10 schematically depicts a storage unit for keeping or carrying a program code, which realizes the method according to the present disclosure.

### DESCRIPTION OF THE EMBODIMENTS

In order that objectives, features and advantages of the disclosure become more apparent, the disclosure will be further described in detail below in conjunction with the accompanying figures in specific embodiments.

When the remote-control equipment in the prior art operates controls in the terminal interface, only a selecting operation can be made to the controls but the remote-control equipment in the prior art cannot conveniently operate the controls in many ways. Therefore, the operating requirements of the user cannot be satisfied. As for above problems, the disclosure provides a method and device for operating controls in terminal based on remote-control equipment, so as to operate the controls in terminal desktop in many ways.

Hereinafter, the method and device for operating controls in terminal based on remote-control equipment according to the disclosure will be discussed in detail by way of examples. The terminal as referred to herein could be smart television as well as computer, cell phone etc., which can be controlled by the remote-control equipment.

### First Embodiment

With reference to FIG. 1, it shows a flow chart of a method for operating controls in a terminal based on remote-control equipment according to a first embodiment of the disclosure. The method may include the steps as follows.

Step 101, obtaining a controls management instruction sent from remote-control equipment to allow controls to enter a displacement control operation mode according to the controls management instruction.

In the embodiment of the disclosure, a displacement control operation mode may be preset in the terminal for the terminal controls, the remote-control equipment may be triggered by a special operation to send the controls management instruction, and then the controls is allowed to enter the displacement control operation mode according to the controls management instruction. Upon the entry to this mode, the displacement control can be made to the controls in the terminal through the remote-control equipment.

Step 102, recognizing an operation instruction sent for the controls in the terminal in the mode from the remote-control equipment.

When the displacement control is need for the controls in the terminal, the operation instruction may be sent for the controls in the terminal in the mode by the remote-control equipment. The operation instruction is used to move the controls in the terminal from a source position to a target position, and upon the receipt of the operation instruction, the terminal may recognize the type of the displacement control that the operation instruction will particularly perform on the controls.

Step 103, moving the controls in the terminal from a source position to a target position in response to the operation instruction.

After the operation instruction is recognized, the terminal may execute corresponding operations in response to the operation instruction in which the controls in the terminal is moved from the source position to the target position.

Specific processes of above steps will be introduced in the second embodiment below.

In this embodiment of the disclosure, after the controls enters the displacement control operation mode, the operation instruction to move the controls in the terminal from the source position to the target position may be triggered by the remote-control equipment, and then the terminal may respond to the operation instruction to execute corresponding operations. Therefore, a variety of operations can be conveniently made to the controls in the terminal through the remote-control equipment to satisfy the operation requirements of the user.

### Second Embodiment

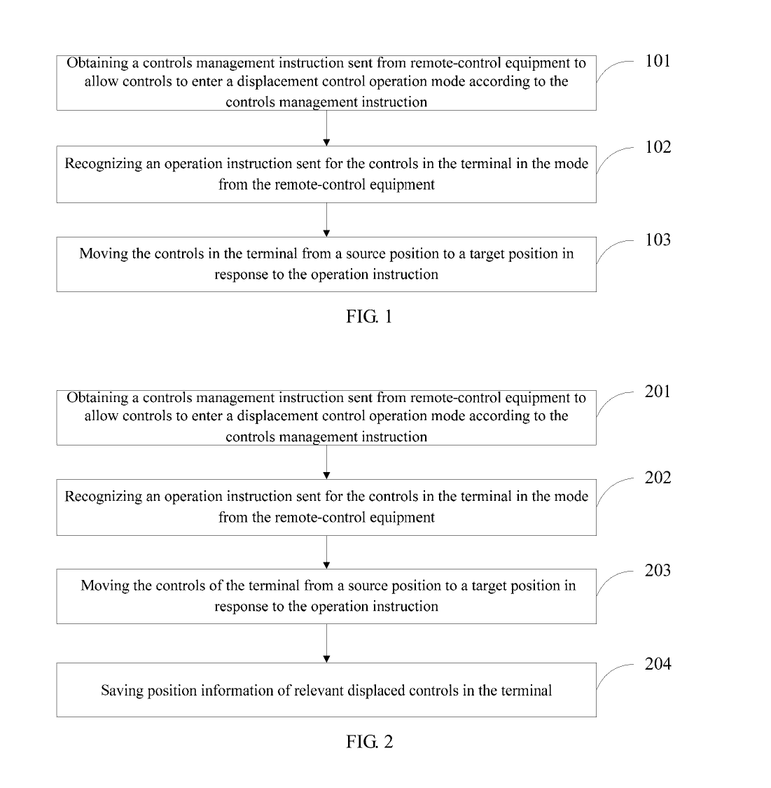

With reference to FIG. 2, it shows a flow chart of a method for operating controls in a terminal based on remote-control equipment according to a second embodiment of the disclosure. The method may particularly include the steps as follows.

Step 201, obtaining a controls management instruction sent from remote-control equipment to allow controls to enter a displacement control operation mode according to the controls management instruction.

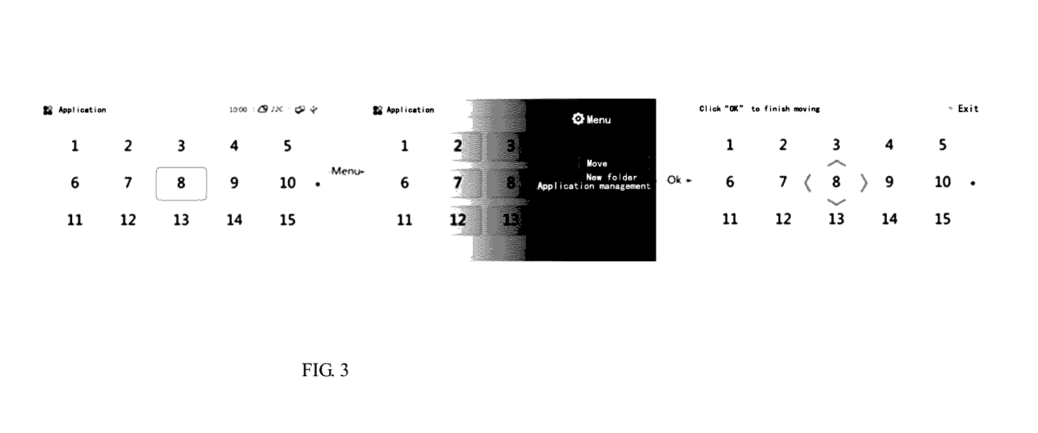

In the embodiment of the disclosure, the remote-control equipment may be triggered by a preset special operation to send the controls management instruction, and in response to the controls management instruction, the control may enter the displacement control operation mode. Herein, controls management instruction may include “select instruction for “Move” option in menu”, “select instruction for “New Folder” option in menu”, “select instruction for “Application Management” option in menu”, etc. In response to the obtained controls management instruction sent from the remote-control equipment, when the controls management instruction is the “select instruction for “Move” option in menu”, the controls is allowed to enter the displacement control operation mode according to the controls management instruction, control. With reference to FIG. 3, it shows a schematic diagram of an entry to a displacement control operation mode according to the second embodiment of the disclosure. As shown in FIG. 3, after the entry to an interface in which controls is displayed, it is possible to click a “Menu” key on the remote-control equipment, to call out a “Move” entry in the menu interface. Then, by selecting the “Move” option in the menu interface and clicking an “OK” key on the remote-control equipment, it is possible to generate the select instruction for “Move” option in menu. Upon the receipt of the select instruction, it is possible to enter the displacement control operation mode. Herein, the interface in which the controls is displayed, could be a main interface of the terminal or a controls child interface of the terminal.

The menu interface as shown in FIG. 3 may further contain the “New Folder” option and “Application management” option. By selecting the “New Folder” option therein and clicking the “OK” key on the remote-control equipment, it is possible to generate the select instruction for “New Folder” option in menu. Upon the receipt of the select instruction, it is possible to create a new folder in the current interface. By selecting the “Application management” option therein and clicking the “OK” key on the remote-control equipment, it is possible to generate the select instruction for “Application Management” option in menu. Upon the receipt of the select instruction, it is possible to manage the applications in the terminal. Of course, the menu interface may contain further options. Corresponding processing could be made to different options in above manner, the detailed description of which will be omitted in the embodiment of the disclosure.

Step 202, recognizing an operation instruction sent for the controls in the terminal in the mode from the remote-control equipment.

Upon the entry to the displacement control operation mode, the remote-control equipment may send the operation instruction for the controls in the terminal in the displacement control operation mode. Upon the receipt of the operation instruction, the terminal may recognize it to determine the operation to be executed. Herein, the operation instruction is used to move the controls in the terminal from a source position to a target position.

In a preferred embodiment of the disclosure, Step 202 may include Sub-Steps of:

Sub-Step a1, determining the controls selected by the remote-control equipment in the mode, and receiving the operation instruction sent for the selected controls from the remote-control equipment, wherein the operation instruction includes moving direction information.

Herein, the step of determining the controls selected by the remote-control equipment in the mode may include: when detecting that a controls gets a focus in the mode and receiving an OK instruction sent for the controls from the remote-control equipment, determining that the controls is the selected controls.

In the embodiment of the disclosure, it is also possible to control the focus to move through the remote-control equipment, such that the controls the user would like to move may get focus. For example, upon the receipt of an initial instruction for the current focus sent from the remote-control equipment, it is possible to convert the initial instruction into a corresponding key event, wherein the key event could include a key value, press action or release action. When detecting a key is pressed and released once, this can determine the key is clicked once. For the current focus, the initial instruction for the current focus can be sent by clicking a directional key on the remote-control equipment. The key value of the directional key may indicate the moving direction information of the current focus. For example, an “up” directional key indicates a distance for upwards moving a controls, and a “down” directional key indicates a distance for downwards moving a controls. After a corresponding key event is obtained by conversion, the key event may be sent to the controls currently getting focus. For example, the key event can be processed by invoking a method of “pagedViewIcon.setOnKeyListener( )”. The controls currently getting focus may determine the controls to get focus according to the key value (i.e., moving direction information) included in the key event and send a message to the controls to get focus; upon the receipt of the message, the controls to get focus may send a request for getting focus and get the focus. For example, the controls may get the focus by invoking a method of “pagedViewIcon.requestFocus( )”.

When a controls gets the focus in the displacement control operation mode, a confirmation instruction for the controls may be sent by clicking the “OK” key on the remote-control equipment. Upon the receipt of the confirmation instruction for the controls sent from the remote-control equipment, the terminal may determine that the controls is the selected controls. If a controls is selected, then a moving operation may be made to the controls by the remote-control equipment. As shown in FIG. 3, after the controls “8” gets the focus in the leftmost drawing, a visual style of the focus is a normal box. After the “OK” key is clicked, the visual style of the focus becomes a four-way arrow, as shown in the rightmost drawing. At this point, the moving operation can be made to the selected controls.

After determining that the controls is selected, an initial instruction for the selected controls can be sent by clicking a directional key on the remote-control equipment. Upon the receipt of the initial instruction, the terminal may convert the initial instruction into a corresponding key event, wherein the key event could include a key value, press action or release action. When detecting a key is pressed and released once, this can determine the key is clicked once. The key value of the directional key may indicate the moving direction information of the current focus. For example, an “up” directional key indicates a distance for upwards moving a controls, and a “down” directional key indicates a distance for downwards moving a controls. An operation instruction which can be recognized by a corresponding application layer may be generated according to the key event. The operation instruction may contain the moving direction information of the selected controls.

Sub-Step a2, judging a type of the target position based on the source position and the moving direction information of the selected controls.

The terminal may obtain position information of the selected controls as the source position of the selected controls, and judging the type of the target position based on the source position of the selected controls and the moving direction information included in the operation instruction.

In a preferred embodiment of the disclosure, the controls may contain application icon, program icon, file icon and folder icon.

Sub-Step a2 may include Sub-Steps of:

Sub-Step a21, if the target position is determined to be a blank position on the terminal main interface based on the source position of the selected control and the moving direction information, then judging the target position to be the blank position on the terminal main interface directly or upon the receipt of the confirmation instruction sent for the selected controls in operation mode from the remote-control equipment;

Sub-Step a22, if the target position is determined to be a position of application icon, program icon or file icon already on the terminal main interface based on the source position of the selected control and the moving direction information, then judging the target position to be the position of the existing controls on the terminal main interface directly or upon the receipt of the confirmation instruction sent for the selected controls in operation mode from the remote-control equipment;

Sub-Step a23, if the target position is determined to be a position of existing folder icon on the terminal main interface based on the source position of the selected control and the moving direction information, then judging the target position to be the position of the existing controls on the terminal main interface directly or upon the receipt of the substitution instruction sent for the selected controls in the operation mode from the remote-control equipment; and

Sub-Step a24, if the target position is determined to be a position of existing folder icon on the terminal main interface based on the source position of the selected control and the moving direction information, then judging the target position to be the position of a controls child interface of the terminal directly or upon the receipt of the confirmation instruction sent for the selected controls in operation mode from the remote-control equipment.

In above Sub-Step a21-Sub-Step a24, the direct judgment may indicate that relevant judgment can be directly made upon the receipt of the operation instruction sent for the selected controls from the remote-control equipment. The judgment upon the receipt of the confirmation instruction sent for the selected controls in operation mode from the remote-control equipment may indicate that, relevant judgment is made upon the receipt of the operation instruction sent for the selected controls from the remote-control equipment and upon the receipt of the confirmation instruction sent for the selected controls in operation mode from the remote-control equipment, wherein the confirmation instruction sent for the selected controls in the operation mode from the remote-control equipment could be an instruction triggered by clicking “OK” key on the remote-control equipment in the operation mode. The judgment upon the receipt of the substitution instruction sent for the selected controls in the operation mode from the remote-control equipment may indicate that, relevant judgment is made upon the receipt of the operation instruction sent for the selected controls from the remote-control equipment and upon the receipt of the substitution instruction sent for the selected controls in the operation mode from the remote-control equipment, wherein the substitution instruction sent for the selected controls in the operation mode from the remote-control equipment could be an instruction by clicking a special key preset on the remote-control equipment in the operation mode.

Herein, the special key could be any key (except for the “OK” key) set on the remote-control equipment as necessary or a special “substitution” key could be added to the remote-control equipment, the implementations of which are not limited by the embodiments of the disclosure.

In Sub-Step a2, by executing above Sub-Step a21-Sub-Step a24, when the target position is judged to be the blank position on the terminal main interface, then Sub-Step a3 is executed; when the target position is judged to be the position of the existing controls on the terminal main interface, then Sub-Step a4 is executed; and when the target position is judged to be the position of a controls child interface of the terminal, then Sub-Step a5 is executed.

Sub-Step a3, recognizing the operation instruction to be a first operation instruction for moving the selected controls from the source position to a specified blank position on a terminal main interface.

Sub-Step a4, recognizing the operation instruction to be a second operation instruction for moving the selected controls from the source position to a specified existing controls position on a terminal main interface.

Sub-Step a5, recognizing the operation instruction to be a third operation instruction for moving the selected controls from the source position to a specified blank position on the terminal specified controls child interface.

Step 203, moving the controls of the terminal from a source position to a target position in response to the operation instruction.

If the operation instruction is recognized to be the first operation instruction for moving the selected controls from the source position to a specified blank position on the terminal main interface at above Step 202, then Step 203 may include a Sub-Step of:

Sub-Step b1, moving the selected controls from the source position to the specified blank position on terminal main interface in response to the first operation instruction.

Herein, the specified blank position on the terminal main interface is the target position judged at above Sub-Step a21, namely the blank position of the terminal main interface.

Sub-Step b1 can be implemented in following two ways:

(1) moving the selected controls from the source position to the specified blank position on the terminal main interface directly in response to the first operation instruction; and

(2) obtaining description information of the selected controls, creating a moving state floating layer corresponding to the selected controls according to the description information; moving the selected controls from the source position to the specified blank position on the terminal main interface in response to the first operation instruction, adding the selected controls to the specified blank position, deleting the controls of the source position and hiding the moving state floating layer.

Herein, the description information of the selected controls may include information of the selected controls such as position index, type, title and background. The position information of controls on the desktop indicates that the position of the controls on the desktop is labeled with an index which is the position index of the controls. The position indices of the controls are stored in a preset database. When the desktop is loaded, the position index of the controls may be read out from the database, and then corresponding controls may be displayed at a relevant position of the desktop according to the position index. The moving state floating layer is used to display the moving process of the selected controls.

If the operation instruction is recognized to be the second operation instruction for moving the selected controls from the source position to the specified existing controls position on the terminal main interface at above Step 202, then Step 203 may include Sub-Step of:

Sub-Step c1, moving the selected controls from the source position to a specified existing controls position on the terminal main interface in response to the second operation instruction.

Herein, the specified existing controls position on the terminal main interface could be the target position judged at above Sub-Step a22, namely the position of the existing controls on the terminal main interface.

Sub-Step c1 can be implemented in following two ways:

(1) moving the selected controls from the source position to a specified existing controls position on the terminal main interface in response to the second operation instruction; and

(2) obtaining description information of the selected controls, creating a moving state floating layer corresponding to the selected controls according to the description information; moving the selected controls from the source position to a specified existing controls position on the terminal main interface in response to the second operation instruction, adding the selected controls to the specified existing controls position, deleting the controls of the source position and hiding the moving state floating layer.

In a preferred embodiment of the disclosure, after Sub-Step c1, following Sub-Step may be executed:

Sub-Step d1, judging the presence of controls between the source position and the specified existing controls position, and if yes, then proceeding to Sub-Step d2; otherwise, proceeding to Sub-Step d3;

Sub-Step d2, controlling the controls between the source position and the specified existing controls position and the controls of the specified existing controls position to displace by a distance of a controls in a direction of the source position;

Sub-Step d3, controlling to move the controls of the specified existing controls position to the source position.

In another preferred embodiment of the disclosure, after above Sub-Step c1, following Sub-Step may be further executed:

Sub-Step e1, controlling to move the controls of the specified existing controls position to the source position or any blank position on its interface.

In another preferred embodiment of the disclosure, after above Sub-Step c1, following Sub-Steps may be further executed:

Sub-Step f1, judging the presence of controls between the source position and the specified existing controls position, and if yes, then proceeding to Sub-Step f2; otherwise proceeding to Sub-Step f3;

Sub-Step f2, controlling the controls between the source position and the specified existing controls position to displace by a distance of a controls in a direction of the source position, and controlling the controls of the specified existing controls position to move to any blank position on its interface;

Sub-Step f3, controlling the controls of the specified existing controls position to move to any blank position on its interface.

If the operation instruction is recognized to be the third operation instruction for moving the selected controls from the source position to a specified blank position on the terminal specified controls child interface at above Step 202, then Step 203 may include Sub-Step of:

Sub-Step g1, moving the selected controls from the source position to a specified blank position on the terminal specified controls child interface in response to the third operation instruction.

Herein, the specified blank position on the terminal specified controls child interface could be the target position judged at above Sub-Step a24, namely a position on a controls child interface of the terminal.

Sub-Step g1 can be implemented in following two ways:

(1) moving the selected controls from the source position to a specified blank position on the terminal specified controls child interface directly in response to the third operation instruction; and

(2) obtaining description information of the selected controls, creating a moving state floating layer corresponding to the selected controls according to the description information; moving the state floating layer from the source position to an upper minified view of the terminal specified controls in response to the third operation instruction, adding the selected controls to the specified blank position on the specified controls child interface, deleting the controls of the source position and hiding the moving state floating layer.

In a preferred embodiment of the disclosure, after above Sub-Step g1, following Sub-Step can be executed:

Sub-Step h1, controlling the controls in front of or behind the source position to displace by a distance of a controls in a direction of the source position.

Of course, Sub-Step h1 could be omitted. In this case, the source position becomes a blank position.

At Step 202, controls in the terminal may include any controls on a terminal main interface or a controls child interface. It should be explained that, if there is a need to move any controls on a controls child interface to the terminal main interface, then a “Move Out” option may be set on the controls child interface. A move-out instruction can be sent after the “Move Out” option is selected through the remote-control equipment. In response to the move-out instruction, the controls can be moved to the terminal main interface.

Step 204, storing position information of relevant displaced controls in the terminal.

In a preferred embodiment of the disclosure, after completing above Step 201-Step 203, it is possible to automatically save the position information of relevant displaced controls in the terminal. It is also possible to save the position information of relevant displaced controls in the terminal at the time of receiving the confirmation instruction sent in the displacement control operation mode from the remote-control equipment (for example, the confirmation instruction is sent by clicking the “OK” key on the remote-control equipment). It is also possible to save the position information of relevant displaced controls in the terminal at the time of triggering the remote-control equipment to quit the displacement control operation mode (for example, an exit instruction is sent by clicking an “Exit” key on the remote-control equipment, and then the remote-control equipment is triggered to quit the displacement control operation mode upon the receipt of the exit instruction).

Hereinafter, specific examples of moving the controls in the terminal from the source position to the target position will be described.

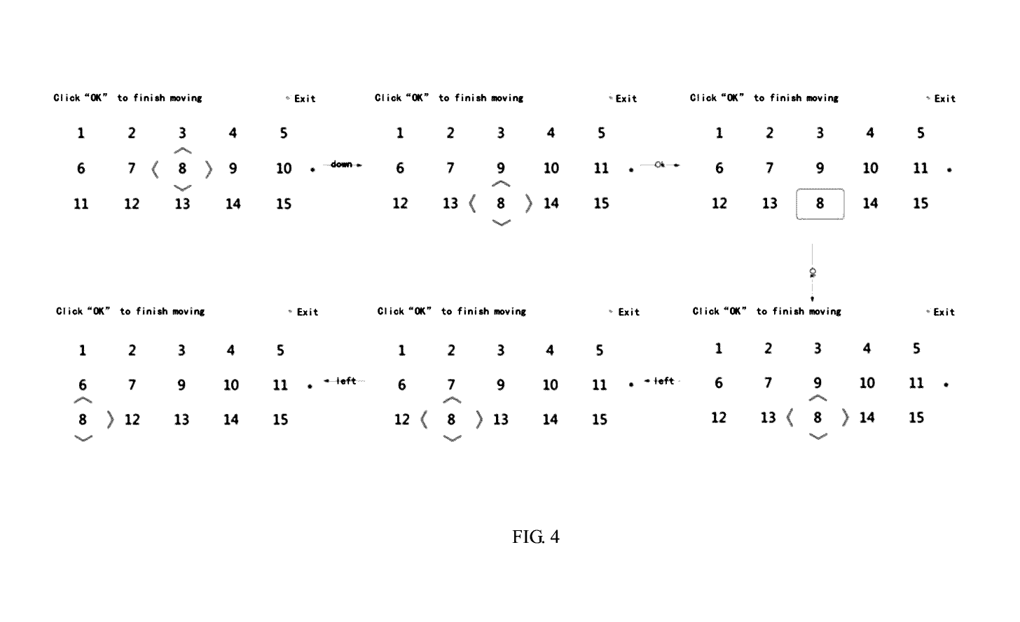

With reference to FIG. 4, it shows a schematic diagram of displacement of controls in a terminal from a source position to a target position according to the second embodiment of the disclosure.

All the controls in FIG. 4 are in the displacement control operation mode. First, controls “8” (corresponding to an interface of Line 1 Column 1) is selected; under the interface of Line 1 Column 1, by clicking a “Down” directional key on the remote-control equipment, the controls “8” is moved to a position of controls “13” just on its underneath side, while controls “9” to controls “13” are controlled to displace by a distance of a controls towards the original position of the controls “8” (corresponding to an interface of Line 1 Column 2); under the interface of Line 1 Column 2, by clicking an “OK” key (i.e., Ok) on the remote-control equipment, a visual style of the focus of controls “8” becomes a normal box, at this point the controls “8” is in an immovable state (corresponding to an interface of Line 1 Column 3), and all controls quit the displacement control operation mode; under the interface of Line 1 Column 3, by clicking the “OK” key (i.e., Ok) on the remote-control equipment, a visual style of the focus of controls “8” becomes a four-way arrow, all controls are in the displacement control operation mode, and at this point the controls “8” is in a movable state (corresponding to an interface of Line 2 Column 3); under the interface of Line 2 Column 3, by clicking a “Left” directional key on the remote-control equipment, controls “8” is moved to a position of controls “13” on its left side, while the controls “13” is controlled to move to the original position of controls “8” (corresponding to an interface of Line 2 Column 2); under the interface of Line 2 Column 2, by clicking the “Left” directional key on the remote-control equipment, the controls “8” is moved to a position of controls “12” on its left side, while controls “12” is controlled to move to the original position of controls “8” (corresponding to an interface of Line 2 Column 1).

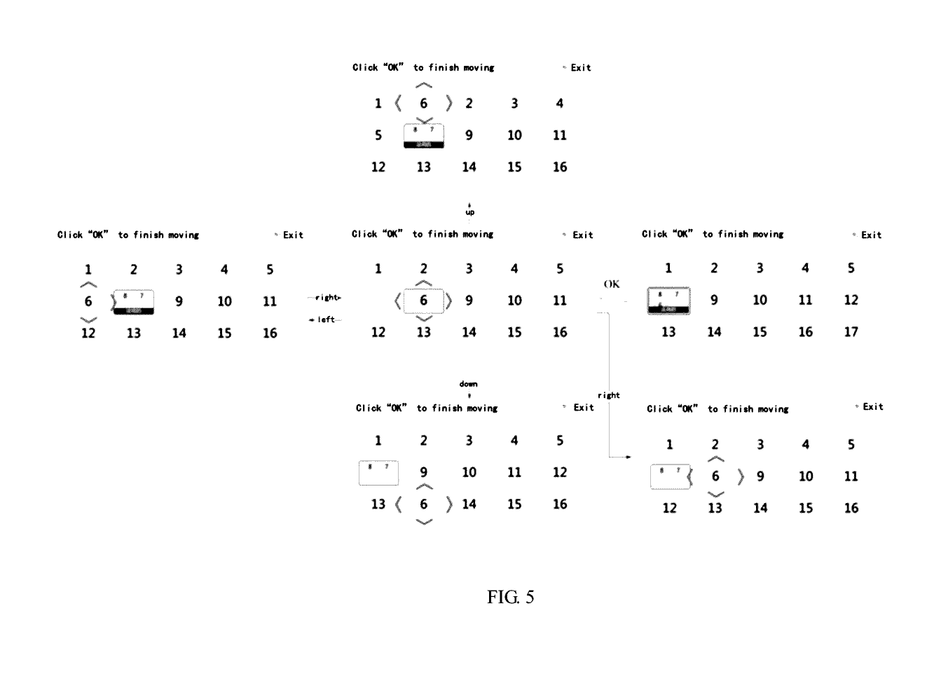

With reference to FIG. 5, it shows another schematic diagram of displacement of controls in a terminal from a source position to a target position according to the second embodiment of the disclosure.

All the controls in FIG. 5 are in the displacement control operation mode. First controls “6” is selected (corresponding to an interface of Line 2 Column 1); under the interface of Line 2 Column 1, by clicking a “Right” directional key on the remote-control equipment, the controls “6” is moved to a position of folder icon on its right side and is displayed with overlapping the folder icon (corresponding to an interface of Line 2 Column 2); under the interface of Line 2 Column 2, by clicking the “Left” directional key on the remote-control equipment, the controls “6” is moved to the original position of the controls “6” (corresponding to an interface of Line 2 Column 1); under the interface of Line 2 Column 1, by clicking an “OK” key (i.e., Ok) on the remote-control equipment, the controls “6” is moved to an interior of the folder icon, while the controls behind the original position of the controls “6” is controlled to displace by a distance of a controls towards the original position of the controls “6” (corresponding to an interface of Line 2 Column 3), and all controls quit the displacement control operation mode; under the interface of Line 2 Column 2, by clicking an “Up” directional key on the remote-control equipment, the controls “6” is moved to the position of the controls “2”, while the controls “2” to controls “5” are controlled to displace by a distance of a controls towards the original position of the controls “6” (corresponding to an interface of Line 1 Column 2); under the interface of Line 2 Column 2, by clicking a “Down” directional key on the remote-control equipment, the controls “6” is moved to the position of the controls “13”, while the folder icon to the controls “13” are controlled to displace by a distance of a controls towards the original position of the controls “6” (corresponding to an interface of Line 3 Column 2); under the interface of Line 2 Column 2, by clicking a “Right” directional key on the remote-control equipment (at this point, corresponding to a sending of a substitution instruction), the controls “6” is moved to a position of the folder icon, while the folder icon is controlled to move to the original position of the controls “6” (corresponding to an interface of Line 3 Column 3).

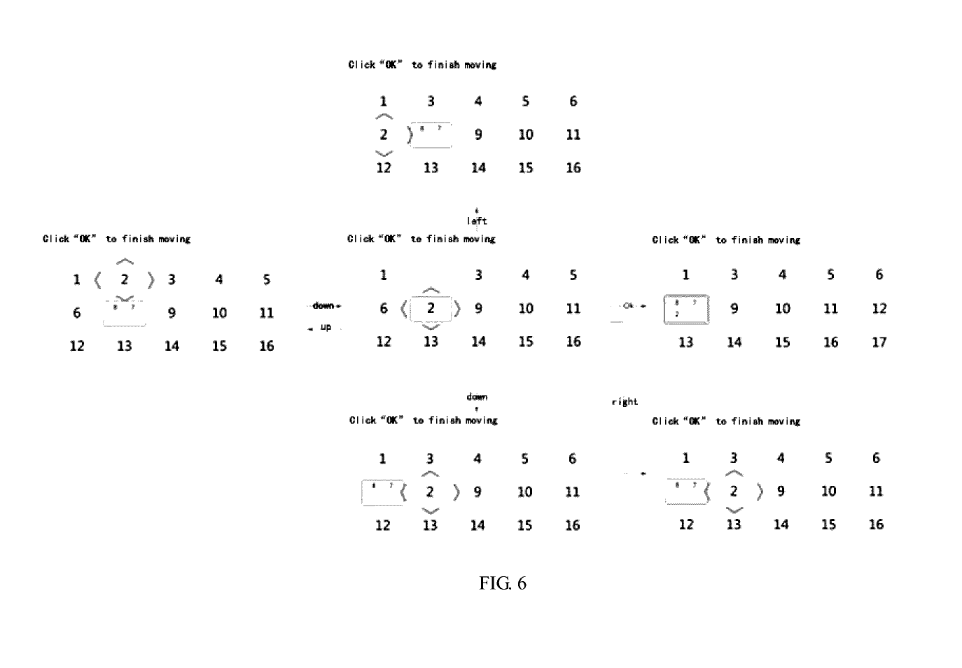

With reference to FIG. 6, it shows still another schematic diagram of displacement of controls in a terminal from a source position to a target position according to the second embodiment of the disclosure.

All the controls in FIG. 6 are in the displacement control operation mode. First, the controls “2” is selected (corresponding to an interface of Line 2 Column 1); under the interface of Line 2 Column 1, by clicking a “Down” directional key on the remote-control equipment, the controls “2” is moved to a position of the folder icon on its underneath side and is displayed with overlapping the folder icon (corresponding to an interface of Line 2 Column 2); under the interface of Line 2 Column 2, by clicking the “Up” directional key on the remote-control equipment, the controls “2” is moved to the original position of the controls “2” (corresponding to an interface of Line 2 Column 1); under the interface of Line 2 Column 2, by clicking an “OK” key (i.e., Ok) on the remote-control equipment, the controls “2” is moved to an interior of the folder icon, while the controls behind the original position of the controls “2” is controlled to displace by a distance of a controls towards the original position of the controls “2” (corresponding to an interface of Line 2 Column 3), and all controls quit the displacement control operation mode; under the interface of Line 2 Column 2, by clicking an “Left” directional key on the remote-control equipment, the controls “2” is moved to the position of the controls “6”, while the controls “3” to the controls “6” are controlled to displace by a distance of a controls towards the original position of the controls “2” (corresponding to an interface of Line 1 Column 2); under the interface of Line 2 Column 2, by clicking a “Down” directional key on the remote-control equipment (at this point, corresponding to a sending of a substitution instruction), the controls “2” is moved to the position of the folder icon, while the controls “3” to the folder icon are controlled to displace by a distance of a controls towards the original position of the controls “2” (corresponding to an interface of Line 3 Column 2); under the interface of Line 2 Column 2, by clicking a “Right” directional key on the remote-control equipment (at this point, corresponding to a sending of a substitution instruction), the controls “2” is moved to the position of the folder icon, while the controls “3” to the folder icon are controlled to displace by a distance of a controls towards the original position of the controls “2” (corresponding to an interface of Line 3 Column 3).

It should be explained that in the three examples as stated above, if the focus is move to an outermost selected controls on the interface and no controls is present on one side of the selected controls, then the focus will become a three-way arrow. In other words, the arrow on the side having no controls will be no longer displayed. At this point, therefore, after clicking a directional key on the remote-control equipment corresponding to the arrow, the controls will be no longer moved. For example, this case may include the controls “8” on the interface of Line 2 Column 1 in FIG. 4, the controls “6” on the interface of Line 2 Column 1 in FIG. 5 and the controls “2” on the interface of Line 1 Column 2 in FIG. 6.

The three examples as stated above are provided for the illustrative purpose, and the embodiments of the disclosure will not be limited to the three implementations.

In this embodiment of the disclosure, a variety of operations can be made to the controls in the terminal through the remote-control equipment, so as to satisfy operating requirements of the user. Further, when the controls in the terminal are excessive, the controls could be neatened in the form of folder to conveniently and efficiently find the controls.

The method embodiments as set forth above, for the purpose of brief description, are described as a series of combined actions. However, it should be appreciated by those skilled in the art that the disclosure should not be restricted by the sequence of the actions as set forth, since some of actions could be performed in different sequence or simultaneously according to the disclosure. Moreover, it should also be appreciated by those skilled in the art that, the embodiments as described in the specification are preferred embodiments, and actions and modules concerned are not necessarily required in the disclosure.

### Third Embodiment

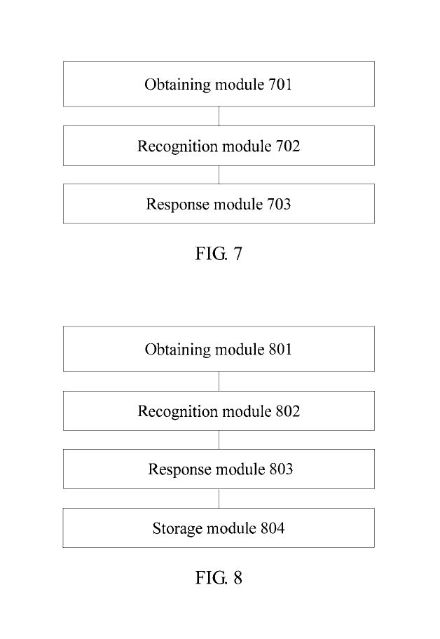

FIG. 7 is a block diagram of a device for operating controls in terminal based on remote-control equipment according to a third embodiment of the disclosure. The device in particular can include following modules:

an obtaining module 701, configured to obtain a controls management instruction sent from remote-control equipment to allow controls to enter a displacement control operation mode according to the controls management instruction;

a recognition module 702, configured to recognize an operation instruction sent for the controls in the terminal in the mode from the remote-control equipment, wherein the operation instruction is used to move the controls in the terminal from a source position to a target position; and

a response module 703, configured to move the controls in the terminal from a source position to a target position in response to the operation instruction.

In this embodiment of the disclosure, upon the entry to the displacement control operation mode for the controls in the terminal through the remote-control equipment, the operation instruction which is used to move the controls in the terminal from a source position to a target position may be sent, and the terminal can be accordingly operated in response to the operation instruction. Therefore, the moving operation could be made to the controls in the terminal through the remote-control equipment, so as to satisfy operating requirements of the user.

### Fourth Embodiment

FIG. 8 is a block diagram of a device for operating controls in terminal based on remote-control equipment according to a fourth embodiment of the disclosure. The device in particular can include following modules:

an obtaining module 801, configured to obtain a controls management instruction sent from remote-control equipment to allow controls to enter a displacement control operation mode according to the controls management instruction;

a recognition module 802, configured to recognize an operation instruction sent for the controls in the terminal in the mode from the remote-control equipment, wherein the operation instruction is used to move the controls in the terminal from a source position to a target position;

a response module 803, configured to move the controls of the terminal from a source position to a target position in response to the operation instruction; and

a storage module 804, configured to store position information of relevant displaced controls in the terminal.

In a preferred embodiment of the disclosure, the recognition module may following sub-modules:

a determination sub-module, configured to determine the controls selected by the remote-control equipment in the mode, and receive the operation instruction sent for the selected controls from the remote-control equipment, wherein the operation instruction includes moving direction information;

a judgment sub-module, configured to judge a type of the target position based on the source position and the moving direction information of the selected controls;

a first recognizing sub-module, configured to recognize the operation instruction to be a first operation instruction for moving the selected controls from the source position to a specified blank position on a terminal main interface when the judgment sub-module judges the target position to be the blank position on the terminal main interface;

a second recognizing sub-module, configured to recognize the operation instruction to be a second operation instruction for moving the selected controls from the source position to a specified existing controls position on a terminal main interface when the judgment sub-module judges the target position to be the position of the existing controls on the terminal main interface; and

a third recognizing sub-module, configured to recognize the operation instruction to be a third operation instruction for moving the selected controls from the source position to a specified blank position on the terminal specified controls child interface when the judgment sub-module judges the target position to be the position on the controls child interface of the terminal.

Herein, the controls may contain application icon, program icon, file icon and folder icon. The controls in the terminal may include any controls on a terminal main interface or a controls child interface.

The determination sub-module in particular can be used to determine the controls to be selected controls when detecting that a controls gets a focus in the mode and receiving a confirmation instruction sent for the controls from the remote-control equipment.

The judgment sub-module may include following sub-modules:

a first judgment sub-module, configured to judge the target position to be the blank position on the terminal main interface directly or upon the receipt of the confirmation instruction sent for the selected controls in operation mode from the remote-control equipment, if the target position is determined to be a blank position on the terminal main interface based on the source position of the selected control and the moving direction information;

a second judgment sub-module, configured to judge the target position to be the position of the existing controls on the terminal main interface directly or upon the receipt of the confirmation instruction sent for the selected controls in operation mode from the remote-control equipment, if the target position is determined to be a position of application icon, program icon or file icon already on the terminal main interface based on the source position of the selected control and the moving direction information;

a third judgment sub-module, configured to judge the target position to be the position of the existing controls on the terminal main interface directly or upon the receipt of the substitution instruction sent for the selected controls in the operation mode from the remote-control equipment, if the target position is determined to be a position of existing folder icon on the terminal main interface based on the source position of the selected control and the moving direction information; and

a third judgment sub-module, configured to judge the target position to be the position of a controls child interface of the terminal directly or upon the receipt of the confirmation instruction sent for the selected controls in operation mode from the remote-control equipment, if the target position is determined to be a position of existing folder icon on the terminal main interface based on the source position of the selected control and the moving direction information.

In a preferred embodiment of the disclosure, the response module may include following sub-modules:

a first response sub-module, configured to move the selected controls from the source position to the specified blank position on terminal main interface in response to the first operation instruction;

a second response sub-module, configured to move the selected controls from the source position to a specified existing controls position on the terminal main interface in response to the second operation instruction; and

a third response sub-module, configured to move the selected controls from the source position to a specified blank position on the terminal specified controls child interface in response to the third operation instruction.

Herein, the second response sub-module in particular can be used to obtain description information of the selected controls, and to create a moving state floating layer corresponding to the selected controls according to the description information, wherein the moving state floating layer can be used to display a moving process of the selected controls; in response to the second operation instruction, to move the moving state floating layer from the source position to the specified existing controls position on the terminal main interface, add the selected controls to the specified existing controls position, delete the controls of the source position and hide the moving state floating layer.

The third response sub-module in particular can be used to obtain description information of the selected controls, and to create a moving state floating layer corresponding to the selected controls according to the description information, wherein the moving state floating layer can be used to display a moving process of the selected controls; in response to the third operation instruction, to move the moving state floating layer from the source position to an upper minified view of the terminal specified controls, add the selected controls to the specified blank position on the specified controls child interface, delete the controls of the source position and hide the moving state floating layer.

In a preferred embodiment of the disclosure, the device may include following modules:

a first control module, configured to judge the presence of controls between the source position and the specified existing controls position, and if yes, control the controls between the source position and the specified existing controls position and the controls of the specified existing controls position to displace by a distance of a controls in a direction of the source position; otherwise, control the controls of the specified existing controls position to move to the source position; and

a second control module, configured to control the controls in front of or behind the source position to displace by a distance of a controls in a direction of the source position.

In this embodiment of the disclosure, by making good use of the keys on the remote-control equipment, it is possible to efficiently realize convenient and prompt operations on the controls at the terminal; and by adding the displacement control operation mode, the operating requirements of the user on the controls can be satisfied.

Since the device embodiments are substantially similar to the method embodiments, the description thereof is relatively simple. For the device embodiments, reference can be made to related parts of the method embodiments.

The various embodiments in the specification have been explained step by step. Each of the embodiments has only emphasized the differences from others, and for the same or similar parts between embodiments, reference could be made to each other.

The disclosure can be described in general context of a computer executable instruction which is executed by the computer, such as a program module. Generally, the program modules may include routine, program, object, component, data structure and the like which can perform particular tasks or implement particular abstract data types. The disclosure can also be practiced in distributed computing environments. In such a distributed computing environment, the program modules can be connected to a remote processing device through a communication network to perform the task. In the distributed computing environment, the program modules may be located in local and remote computer storage medium including a memory device.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

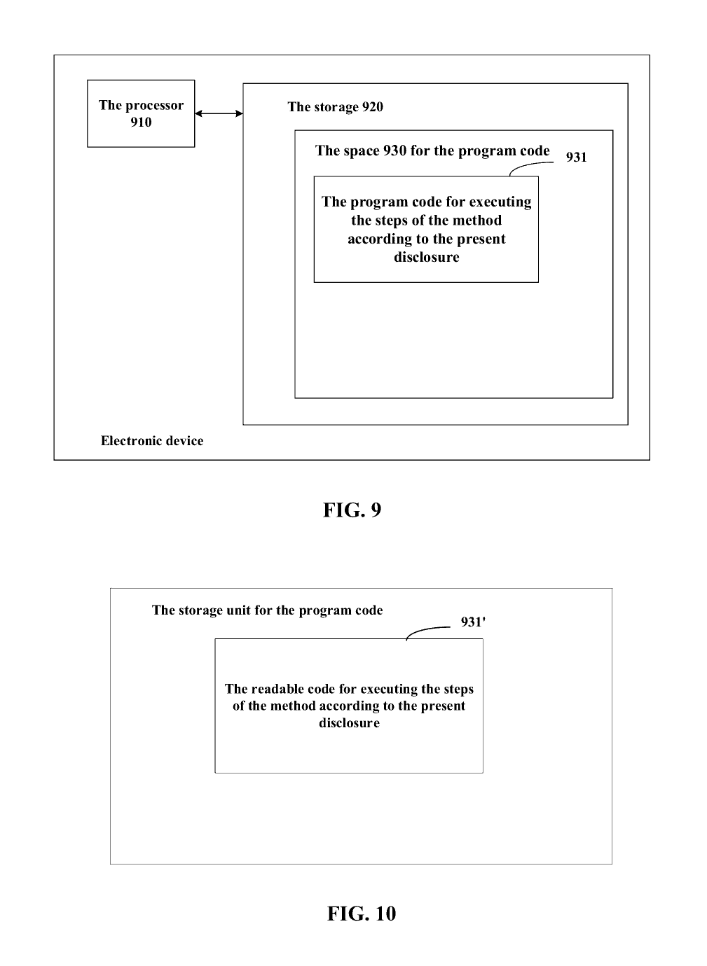

For example, FIG. 9 illustrates a block diagram of an electronic device for executing the method according the disclosure. Traditionally, the electronic device includes a processor 910 and a computer program product or a computer readable medium in form of a memory 920. The memory 920 could be electronic memories such as flash memory, EEPROM (Electrically Erasable Programmable Read-Only Memory), EPROM, hard disk or ROM. The memory 920 has a memory space 930 for executing program codes 931 of any steps in the above methods. For example, the memory space 930 for program codes may include respective program codes 931 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 10. The memory cells may be provided with memory sections, memory spaces, etc., similar to the memory 920 of the server as shown in FIG. 9. The program codes may be compressed for example in an appropriate form. Usually, the memory cell includes computer readable codes 931′ which can be read for example by processors 910. When these codes are operated on the server, the server may execute respective steps in the method as described above.

In the context, it will also be explained that, the relative terms “first”, “second”, etc. are only used herein to distinguish one element or operation from one another, and does not necessarily require or suggest that there are any actual relationship or sequence between these elements or operations. Further, the terms “comprise”, “include” and any other variants thereof are intended to cover a non-exclusive “comprise”, so that process, method, product or equipment which includes a series of elements may include not only those elements, but also other elements that do not be definitely listed, or also may include the inherent elements of the process, method, product or equipment. In the absence of more restrictions, an element defined by the statement “includes a . . . ” does not mean to exclude other same elements in the process, method, product or equipment including this element.

It would be understood by an ordinary skilled in the art, all or some of steps in the method embodiments as described above can be implemented by means of hardware corresponding to program instructions. The aforesaid program can be stored in computer readable storage medium. The execution of the program includes the execution of the steps in the method embodiments as described above. The aforesaid storage medium may include ROM, RAM, magnetic disc, optical disc and any other medium which is able to store the program codes.

In the end, it should be explained that aforesaid embodiments are provided for the purpose of illustrating not limiting the technical schemes of the disclosure. Although the disclosure has been described in detail with reference to the embodiments, it should be understood by those skilled in the art that modifications or equivalent substitutions can be made to the technical schemes or some of technical features therein as disclosed in the embodiments; the modifications or substitutions will not bring the essence of the respective technical schemes to depart from the scope of the technical schemes of the inventive embodiments.

What is claimed is:

1. A method for operating controls in a terminal based on remote-control equipment, wherein the method comprises steps of:
obtaining a controls management instruction sent from remote-control equipment to allow controls to enter a displacement control operation mode according to the controls management instruction;
recognizing an operation instruction sent for the controls in the terminal in the mode from the remote-control equipment; and
moving the controls in the terminal from a source position to a target position in response to the operation instruction.

2. The method according to claim 1, wherein the method further comprises:
storing position information of relevant displaced controls in the terminal.

3. The method according to claim 1, wherein the controls comprise application icon, program icon, file icon and folder icon.

4. The method according to claim 3, wherein the step of recognizing an operation instruction sent for the controls in the terminal in the mode from the remote-control equipment, comprises:
determining the controls selected by the remote-control equipment in the mode, and receiving the operation instruction sent for the selected controls from the remote-control equipment, wherein the operation instruction includes moving direction information;
judging a type of the target position based on the source position and the moving direction information of the selected controls;
recognizing the operation instruction to be a first operation instruction for moving the selected controls from the source position to a specified blank position on a terminal main interface, when the target position is judged to be the blank position on the terminal main interface;
recognizing the operation instruction to be a second operation instruction for moving the selected controls from the source position to a specified existing controls position on the terminal main interface, when the target position is judged to be the position of the existing controls on the terminal main interface; and
recognizing the operation instruction to be a third operation instruction for moving the selected controls from the source position to a specified blank position on the terminal specified controls child interface, when the target position is judged to be the position on a controls child interface of the terminal.

5. The method according to claim 4, wherein the step of moving the controls of the terminal from a source position to a target position in response to the operation instruction, comprises:
moving the selected controls from the source position to a specified existing controls position on the terminal main interface in response to the second operation instruction, the method further comprises:
judging the presence of controls between the source position and the specified existing controls position, and if yes, then controlling the controls between the source position and the specified existing controls position and the controls of the specified existing controls position to displace by a distance of a controls in a direction of the source position;
otherwise, controlling to move the controls of the specified existing controls position to the source position.

6. The method according to claim 4, wherein the step of moving the controls of the terminal from a source position to a target position in response to the operation instruction, comprises:
moving the selected controls from the source position to a specified blank position on the terminal specified controls child interface in response to the third operation instruction, the method further comprises:
controlling the controls in front of or behind the source position to displace by a distance of a controls in a direction of the source position.

7. The method according to claim 4, wherein the step of judging a type of the target position based on the source position and the moving direction information of the selected controls, comprises:
judging the target position to be the blank position on the terminal main interface directly or upon the receipt of the confirmation instruction sent for the selected controls in operation mode from the remote-control equipment, if the target position is determined to be a blank position on the terminal main interface based on the source position of the selected control and the moving direction information;
judging the target position to be the position of the existing controls on the terminal main interface directly or upon the receipt of the confirmation instruction sent for the selected controls in operation mode from the remote-control equipment, if the target position is determined to be a position of application icon, program icon or file icon already on the terminal main interface based on the source position of the selected control and the moving direction information;
judging the target position to be the position of the existing controls on the terminal main interface directly or upon the receipt of the substitution instruction sent for the selected controls in the operation mode from the remote-control equipment, if the target position is determined to be a position of existing folder icon on the terminal main interface based on the source position of the selected control and the moving direction information; and
judging the target position to be the position of a controls child interface of the terminal directly or upon the receipt of the confirmation instruction sent for the selected controls in operation mode from the remote-control equipment, if the target position is determined to be a position of existing folder icon on the terminal main interface based on the source position of the selected control and the moving direction information.

8. The method according to claim 1, wherein the controls in the terminal comprise any controls on the terminal main interface or the controls child interface.

9. The method according to claim 4, wherein the step of determining the controls selected by the remote-control equipment in the mode, comprises:
when detecting that a controls gets a focus in the mode and receiving a confirmation instruction sent for the controls from the remote-control equipment, determining that the controls is the selected controls.

10. An electronic device for operating controls in terminal based on remote-control equipment, wherein the electronic device comprises:
at least one processor; and
a memory communicably connected with the at least one processor for storing instructions executable by the at least one processor, wherein execution of the instructions by the at least one processor causes the at least one processor to:
obtain a controls management instruction sent from remote-control equipment to allow controls to enter a displacement control operation mode according to the controls management instruction;
recognize an operation instruction sent for the controls in the terminal in the mode from the remote-control equipment, wherein the operation instruction is used to move the controls in the terminal from a source position to a target position; and
move the controls in the terminal from a source position to a target position in response to the operation instruction.

11. The electronic device according to claim 10, wherein the execution of the instructions by the at least one processor causes the at least one processor to further:
store position information of relevant displaced controls in the terminal.

12. The electronic device according to claim 10, wherein the controls comprise application icon, program icon, file icon and folder icon.

13. The electronic device according to claim 12, wherein recognize an operation instruction sent for the controls in the terminal in the mode from the remote-control equipment comprises:
determine the controls selected by the remote-control equipment in the mode, and receive the operation instruction sent for the selected controls from the remote-control equipment, wherein the operation instruction includes moving direction information;
judge a type of the target position based on the source position and the moving direction information of the selected controls;
recognize the operation instruction to be a first operation instruction for moving the selected controls from the source position to a specified blank position on a terminal main interface when the target position is judged to be the blank position on the terminal main interface;
recognize the operation instruction to be a second operation instruction for moving the selected controls from the source position to a specified existing controls position on a terminal main interface when the target position is judged to be the position of the existing controls on the terminal main interface; and
recognize the operation instruction to be a third operation instruction for moving the selected controls from the source position to a specified blank position on the terminal specified controls child interface when the target position is judged to be the position on the controls child interface of the terminal.

14. The electronic device according to claim 13, wherein move the controls in the terminal from a source position to a target position in response to the operation instruction comprises:
move the selected controls from the source position to a specified existing controls position on the terminal main interface in response to the second operation instruction,
the execution of the instructions by the at least one processor causes the at least one processor to further:
judge the presence of controls between the source position and the specified existing controls position, and if yes, control the controls between the source position and the specified existing controls position and the controls of the specified existing controls position to displace by a distance of a controls in a direction of the source position; otherwise, control the controls of the specified existing controls position to move to the source position.

15. The electronic device according to claim 13, wherein move the controls in the terminal from a source position to a target position in response to the operation instruction comprises:
move the selected controls from the source position to a specified blank position on the terminal specified controls child interface in response to the third operation instruction.
the execution of the instructions by the at least one processor causes the at least one processor to further:
control the controls in front of or behind the source position to displace by a distance of a controls in a direction of the source position.

16. The electronic device according to claim 13, wherein judge a type of the target position based on the source position and the moving direction information of the selected controls comprises:
judge the target position to be the blank position on the terminal main interface directly or upon the receipt of the confirmation instruction sent for the selected controls in operation mode from the remote-control equipment, if the target position is determined to be a blank position on the terminal main interface based on the source position of the selected control and the moving direction information;
judge the target position to be the position of the existing controls on the terminal main interface directly or upon the receipt of the confirmation instruction sent for the selected controls in operation mode from the remote-control equipment, if the target position is determined to be a position of application icon, program icon or file icon already on the terminal main interface based on the source position of the selected control and the moving direction information;
judge the target position to be the position of the existing controls on the terminal main interface directly or upon the receipt of the substitution instruction sent for the selected controls in the operation mode from the remote-control equipment, if the target position is determined to be a position of existing folder icon on the terminal main interface based on the source position of the selected control and the moving direction information; and
judge the target position to be the position of a controls child interface of the terminal directly or upon the receipt of the confirmation instruction sent for the selected controls in operation mode from the remote-control equipment, if the target position is determined to be a position of existing folder icon on the terminal main interface based on the source position of the selected control and the moving direction information.

17. The electronic device according to claim 10, wherein the controls in the terminal comprise any controls on the terminal main interface or the controls child interface.

18. The electronic device according to claim 13, wherein determine the controls selected by the remote-control equipment in the mode, and receiving the operation instruction sent for the selected controls from the remote-control equipment comprises: determine the controls to be selected controls when detecting that a controls gets a focus in the mode and receiving a confirmation instruction sent for the controls from the remote-control equipment.

19. A non-transitory computer readable recording medium storing executable instructions that, when executed by an electronic device with a touch-sensitive display, cause the electronic device to:
obtain a controls management instruction sent from remote-control equipment to allow controls to enter a displacement control operation mode according to the controls management instruction;
recognize an operation instruction sent for the controls in the terminal in the mode from the remote-control equipment; and
move the controls in the terminal from a source position to a target position in response to the operation instruction.
